(19) United States
(12) Patent Application Publication
(10) Pub. No.: US 2017/0349725 A1
(43) Pub. Date: Dec. 7, 2017

(54) OLIGOTERPENES AS REJUVENATING AGENT IN ASPHALT

(71) Applicant: Arizona Chemical Company, LLC, Jacksonville, FL (US)

(72) Inventor: David Jan Cornelis BROERE, Amsterdam (NL)

(73) Assignee: Arizona Chemical Company, LLC, Jacksonville, FL (US)

(21) Appl. No.: 15/523,961

(22) PCT Filed: Dec. 17, 2015
(86) PCT No.: PCT/EP2015/080283

§ 371 Date: May 3, 2017

(30) Foreign Application Priority Data
Dec. 22, 2014 (EP) 14199872.4

(51) Int. Cl. C08K 5/01; C08L 95/00

(52) U.S. Cl. CPC C08K 5/01; C08L 95/00; C08L 2555/62; C08L 2555/34

(57) ABSTRACT

An asphalt mixture comprising an oligoterpene composition and reclaimed asphalt and/or virgin asphalt, a method of preparing said asphalt mixture, a bituminous binder-oligoterpene blend and a method for rejuvenating reclaimed asphalt or treating virgin asphalt are disclosed, wherein the oligoterpene composition comprises at least one oligoterpene with at least two isoprene moieties selected from a diterpene, a triterpene, a tetraterpene, a pentaterpene and a hexaterpene. The method of preparing an asphalt mixture comprises mixing the oligoterpene composition with reclaimed asphalt and/or virgin asphalt. The oligoterpene-bituminous binder blend, comprises 0.5-50 wt. % of the oligoterpene composition based on the total weight of the blend. The method for rejuvenating reclaimed asphalt or treating virgin asphalt comprises mixing the oligoterpene composition with reclaimed asphalt or virgin asphalt to form a modified asphalt.

The instant invention relates to an asphalt mixture comprising an oligoterpene composition and reclaimed asphalt and/or virgin asphalt, to a method for preparing said asphalt mixture, to a blend of bituminous binder and oligoterpene and to a method for treating virgin asphalt or rejuvenating reclaimed asphalt (e.g. reclaimed asphalt pavement and reclaimed asphalt shingles or reclaimed asphalt membranes from roofing applications).

The paving industry has become increasingly interested in the re-use of used asphalt, which is generally known as reclaimed asphalt. Reclaimed asphalt may typically be asphalt which has been used in, e.g., pavement applications (reclaimed asphalt pavement or RAP), and asphalt used in other applications, e.g., in roofing such as reclaimed asphalt shingles or reclaimed asphalt membranes, or combinations thereof.

Reclaimed asphalt is currently combined with virgin asphalt for re-use purposes. In order to reduce both the amount of virgin materials used by the paving industry and the amount of waste and landfill that it generates, the aim is to use reclaimed asphalt as much as possible in asphalt mixtures for paving applications or other applications such as roofing.

Asphalt, in paving and other applications, deteriorates with time, losing flexibility, becoming brittle and having an increased tendency to crack, in particular at low temperatures. These effects are generally attributed to the chemical modification of the organic phase of asphalt, i.e. bitumen, during ageing, especially on exposure to outdoor weather. Consequently, asphalt paving can be difficult to recycle as it has different properties than virgin asphalt. For example, untreated reclaimed asphalt generally has a higher viscosity profile over a temperature range of 100 to 180° C. and a higher softening point. Thus, to improve the properties and the lifetime of a pavement comprising reclaimed asphalt, the amount of reclaimed asphalt in asphalt mixtures that can be used for paving has been limited.

Asphalt used in paving applications may be described to be found in a base course of a paving structure, closest to the earth, and in a surface course of a paving structure, at the surface meeting the air. Generally, an asphalt mixture comprising up to 30 wt. % of reclaimed asphalt is currently used in the base course of a pavement. Due to the higher demands of the surface of the pavement, generally a lower amount of untreated reclaimed asphalt, or even no untreated reclaimed asphalt, is used in the surface course, depending on the structure of the surface. For instance, a dense-asphalt surface course, may use up to 15 wt. % of reclaimed asphalt. On the other hand, generally no reclaimed asphalt is used in porous-asphalt or mastic-asphalt surfaces. In order to increase the amount of reclaimed asphalt in the base and surface courses, additives, such as rejuvenating agents, may be used.

To allow for better use of reclaimed asphalt, the industry has developed rejuvenating agents (also known as recycling agents) to restore, a portion of the asphalt properties, such as viscoelastic behavior, so that the reclaimed asphalt properties resemble those of virgin asphalt. Improving the properties of reclaimed asphalt allows increased amounts of reclaimed asphalt to be used in asphalt mixtures for, e.g., paving applications without compromising the properties and life time of the final pavement. Commonly used rejuvenating agents include low viscosity products obtained by crude oil distillation. Rejuvenating agents of plant origin have also been described.

WO2013090283 discloses the use of tall oil fatty acid based ester with cyclic content to be active for restoring the properties of bituminous binders found in RAP.

US 2010/0034586 discloses a rejuvenating agent suitable for rejuvenating asphalt (containing RAP), wherein said rejuvenating agent comprises one or more plant derived oils.

US 2010/0041798 discloses a rejuvenating agent having a viscosity of from 200 to 60000 cSt at 60° C. and comprising 10-90 wt. % palm oil and 90-10 wt. % bitumen, based upon the total weight of the composition.

WO 2010/107134 describes an asphalt modifier (i.e. bitumen modifier) prepared by mixing a vinyl aromatic hydrocarbon-conjugated diene block copolymer, a tackifying resin, and a process oil. Examples of the tackifying resin include a coumarone-indene resin, a phenol resin, a p-t-butylphenol-acetylene resin, a phenol-formaldehyde resin, a terpene-phenol resin, a polyterpene resin, a xylene-formaldehyde resin, a C5-based petroleum resin, a C9-based petroleum resin, a dicyclopentadiene-based resin, polybutene, and rosin or a hydrogenated product thereof, or a modified product thereof with maleic anhydride or the like. A C5-based petroleum resin, a C9-based petroleum resin and a dicyclopentadiene-based resin are preferred.

The asphalt modifier described in WO 2010/107134 can provide an asphalt composition and an asphalt mixture which is improved in high-temperature properties, such as the rutting resistance, and low-temperature properties, such as the thermal stress crack. This document only discloses the generic application of this material as an alternative to other known asphalt compositions and only discloses the application of this material in road pavement in general. The asphalt compositions as disclosed in this document do not contain reclaimed asphalt pavement and this document neither discloses nor suggests the use of oligoterpenes.

A discovery of the present invention is that the use of oligoterpenes as an additive to rejuvenate reclaimed asphalt pavement allows a larger amount of reclaimed asphalt to be used in base and surface pavement courses. The oligoterpenes act as improved rejuvenating agents. In particular, they improve the properties of bituminous mixtures where the bituminous mixtures comprise aged bitumen or bitumen originating from reclaimed asphalt. It has also been found that oligoterpenes not only have a rejuvenating effect on reclaimed asphalt but also on virgin asphalt, may improve its ageing properties.

Accordingly, one aspect of the present invention relates to an asphalt mixture comprising an oligoterpene composition and reclaimed asphalt and/or virgin asphalt. Another aspect of the present invention relates to a method for preparing such an asphalt mixture. Yet another aspect of the present invention relates to a blend of bituminous binder and an oligoterpene composition suitable for mixing with reclaimed asphalt pavement in an asphalt mixture. Yet another aspect of the present invention relates to a method for rejuvenating reclaimed asphalt.

The asphalt mixtures as described herein comprise an oligoterpene composition and reclaimed asphalt and/or virgin asphalt. In some cases where the asphalt mixture comprises reclaimed asphalt, in addition to the oligoterpene and the bituminous binder and aggregate already present in reclaimed asphalt, it is desirable for the asphalt mixture to comprise at additional bituminous binder and/or aggregate, i.e. bituminous binder and/or aggregate from other sources. In one embodiment such asphalt mixtures comprise an oligoterpene composition, reclaimed asphalt and additional bituminous binder. In yet another embodiment, the asphalt mixtures may comprise an oligoterpene composition reclaimed asphalt, additional bituminous binder and aggregate. The choice of bituminous binder and aggregate may be determined by the availability and/or the final paving application of the asphalt mixture. In one particular embodiment such asphalt mixtures may comprise virgin asphalt in addition to reclaimed asphalt and oligoterpene composition. Virgin asphalt comprises virgin bitumen and virgin aggregate.

The term “asphalt” as used in the present description refers to the composite material comprising a bituminous binder and optionally aggregate, which is generally used for paving applications and/or roofing application. Examples of asphalt used in paving applications include dense graded asphalt, gap graded asphalt, porous asphalt and mastic asphalt. Asphalt as used herein includes reclaimed asphalt and virgin asphalt. Typically, the total amount of bituminous binder in asphalt that also comprises aggregate is from 1 to 10 wt. % based on the total weight of the asphalt, in some cases from 2.5 to 8.5 wt. % and in some cases from 4 to 7.5 wt. %. Higher amounts of bituminous binder may be present in asphalt which does not comprise aggregate, e.g. used in roofing applications. For instance, the bituminous binder may be from 25 to 100 wt. %, in particular from 50 to 99 wt. %, and more in particular from 75 to 95%. The term “reclaimed asphalt” refers to asphalt that has been used previously as pavement or other applications such as roofing, and comprises an aged bituminous binder and, optionally, aggregate. Reclaimed asphalt may be obtained from asphalt which has been removed from a road or other structure, and then has been processed by methods known to the skilled person, including milling, ripping, breaking, crushing and/or pulverizing. Prior to use, the reclaimed asphalt may be inspected, sized and selected, for instance, depending on the final paving application.

The term “virgin asphalt” refers to asphalt comprising virgin bitumen and, optionally, virgin aggregate.

The term “aggregate” (also known as “construction aggregate”) refers to the common meaning in the asphalt field of this term, i.e. any particulate mineral material suitable for use in asphalt. It may generally comprise sand, gravel, crushed stone and slag. Such aggregate is commonly used in the field of asphalt. Any conventional type of aggregate suitable for use in asphalt known to the skilled person may be used. Examples of suitable aggregates include granite, limestone, gravel and mixtures thereof. Virgin aggregate is aggregate which has not been used, e.g., which has not been recovered from a road pavement.

The term “bitumen” as used in asphalt art refers to a mixture of highly viscous organic liquids or semi-solids from crude oil origin that is black, sticky, entirely soluble in carbon disulfide, and composed primarily of highly condensed polycyclic aromatic hydrocarbons. Alternatively, in the relevant technical field it is common to refer to bitumen as a mixture of maltenes and asphaltenes. Bitumen may be any conventional type of bitumen known to skilled person. The bitumen may be naturally occurring bitumen, crude bitumen or may be refined bitumen obtained as the bottom residue in the vacuum distillation process of crude oil, thermal cracking processes or hydrogen cracking processes. In the present description, the term bitumen includes aged bitumen, e.g. bitumen that is contained in or obtained from reclaimed asphalt and is referred to as bitumen of reclaimed asphalt origin. On the other hand, in the present description, the term bitumen includes virgin bitumen (also known in the art as fresh bitumen), which refers to bitumen which has not been used, e.g., which has not been recovered from a road pavement.

The term “bituminous binder” as used in the present description refers to bitumen (e.g., virgin bitumen or aged bitumen) which is optionally combined with supplementary components (e.g. plastomers and/or elastomers). The bituminous binder may consist of 100% bitumen or may be a combination of at least 20% bitumen and supplementary components. The content of supplementary components in the bituminous binder, if any, may be as high as 80 wt % based on the total weight of bituminous binder, but generally may be of at most 60 wt. %, at most 50 wt. %, at most 30 wt. %, or at most 20 wt. %.

The bitumen in the bituminous binder may be commercially available virgin bitumen such as paving grade bitumen, i.e. suitable for paving applications. Examples of commercially available paving grade bitumen include, for instance, bitumens which in the Penetration grade (PEN) classification system are referred to as PEN 35/50, 40/60 and 70/100 or bitumens which in the Performance grade (PG) classification system are referred to as PG 64-22, 58-22, 70-22 and 64-28. Such bitumens are available from, for instance, Shell, Total and British Petroleum (BP). In the PEN classification the numeric designation refers to the penetration range of the bitumen as measured with the ASTM D1586 method, e.g. a 40/60 PEN bitumen corresponds to a bitumen with a penetration which ranges from 40 to 60 decimillimeters (dmm). In the PG classification (AASHTO MP 1 specification) the first value of the numeric designation refers to the high temperature performance and the second value refers to the low temperature performance as measured by a method which is known in the art as the Superpave system. Bitumen of lower quality having low cohesion and adhesion characteristics, meaning decreased performance at low temperature and lower affinity to aggregates, may also be used. Alternatively, the bitumen in the bituminous binder may include aged bitumen such as bitumen of reclaimed asphalt origin obtained from, e.g., reclaimed asphalt pavement

The supplementary components in the bituminous binder may include components that are commonly used and/or suitable for use in asphalt. The supplementary components may be, for example, elastomers, plastomers, and non-bituminous binders. For instance, the bituminous binder may preferably be polymer modified bitumen. Other supplementary components may include, for example, adhesion promoters, softening agents, additional rejuvenating agents (other than those of the invention), and other additives that are suitable for asphalt applications and generally known in the paving industry.

Useful elastomers may be selected from at least one of ethylene-vinyl acetate copolymers, polybutadienes, ethylene-propylene copolymers, ethylene-propylene-diene terpolymers, butadiene-styrene diblock copolymers, styrene-butadiene-styrene (SBS) triblock terpolymers, isoprene-styrene diblock copolymers and styrene-isoprene-styrene (SIS) triblock terpolymers. Cured elastomer additives may include ground tire rubber materials.

Non-bituminous binders as described in the documents US 2011/0015312 and EP 1466878 may be used. EP 1466878 describes a binder comprising (a) 2 to 98% by weight of at least one natural or modified natural resin, of vegetable origin, having a softening point of 30-200° C.; (b) 98-2% by weight of at least one oil of vegetable origin having a viscosity at 25° C. of 50 mPa·s-1000 Pa·s; where the binder has either a penetrability at 25° C. of 2 to 30 mm (i.e. 20-300 dmm, as commonly referred to in the art) and a softening point of 30-75° C. or a penetrability at 15° C. of 30 to 90 mm (i.e. 300 to 900 dmm, as commonly referred to in the art) and a viscosity at 60° C. of 2-20 Pa·s; and where binder is free of all natural or synthetic elastomers and all thermoplastic polymers. US 2011/0015312 describes a binder composition comprising a resin of vegetable origin, an oil of vegetable origin and a polymer, characterized in that the polymer comprises functional groups chosen from carboxylic acid anhydride, carboxylic acid and epoxide groups. Commercially available non-bituminous binders may also be used.

As elucidated in more detail below, the supplementary components may be added separately from the bitumen to the asphalt mixture, they may be added as a pre-mix with bitumen or they may be added as pre-mix with the other components of the asphalt mixture. For example, such supplementary components may pre-mixed with the oligoterpene, the reclaimed asphalt and/or aggregate.

The oligoterpene composition as described herein comprises at least one oligoterpene with at least two isoprene moieties. The oligoterpene may be selected from, for instance, at least one of a diterpene, a triterpene, a tetraterpene, a pentaterpene and a hexaterpene, each comprising 4, 6, 8, 10 and 12 units, respectively, of said isoprene moieties. Higher oligoterpenes generally do not present the right properties for use as rejuvenating agents for reclaimed asphalt. In particular, such higher oligoterpenes have viscosities which are too high for adequate interaction with the bitumen in reclaimed asphalt pavement.

In one embodiment at least one of said isoprene moieties may comprise substituents such as alkyl (e.g. methyl, ethyl, propyl, isopropyl, butyl, isobutyl) and aryl (e.g. phenyl and benzyl).

In one embodiment the oligoterpene composition may be free or substantially free of monoterpene. That the oligoterpene composition is substantially free of monoterpene means that the oligoterpene composition comprises at most 0.5 wt. % of monoterpene, in particular at most 0.2 wt. %, based on the total of weight of the oligoterpene composition. Oligoterpene compositions which are free or substantially free of monoterpene advantageously have reduced flammability. Such oligoterpene compositions render the asphalt mixtures as described herein safer and more suited for use in paving applications where the risk of flammability, e.g. upon a car accident, is to be reduced.

In another embodiment the oligoterpene composition may comprise at least a diterpene. In a particular embodiment the oligoterpene composition may further comprise a triterpene. In yet a particular embodiment the oligoterpene composition may further comprise a tetraterpene and a hexaterpene. In yet a particular embodiment the oligoterpene composition may further comprise a pentaterpene.

An oligoterpene composition comprising different oligoterpenes, and in particular the oligoterpene combinations as described herein, particularly a mixture of diterpene, triterpene, tetraterpene, pentaterpene and hexaterpene, advantageously improves the performance of mixtures containing bitumen of reclaimed asphalt origin. Said oligoterpene compositions also have good cohesion and adhesion with aggregates, bitumen and reclaimed asphalt.

In one embodiment the oligoterpene composition may comprise at least 65 wt. % of a combination of diterpene, triterpene, tetraterpene, pentaterpene and hexaterpene, in particular at least 75 wt. %, 90 wt. %, 95 wt. % or 98 wt. %. In a particular embodiment the oligoterpene composition may comprise: 25-50 wt. %, in particular 30-40 wt. %, of a diterpene; 15-30 wt. %, in particular 20-25 wt. %, of a triterpene; 10-25 wt. %, in particular 15-20 wt. % of a tetraterpene; 5-10 wt. %, in particular 5-7.5 wt. % of a pentaterpene; and 10-25 wt. %, in particular 10-15 wt. % of an hexaterpene. The remaining components of the oligoterpene composition adding to 100 wt. % may be, for instance, at least one of a monoterpene, an oligoterpene higher than a hexaterpene (e.g. heptaterpene, octaterpene, decaterpene etc.) and a polyterpene.

The composition of an oligoterpene composition as described herein may be determined by methods known to the skilled person. For instance, the ASTM D6579-00 method for determining the molecular weight averages and molecular weight distribution of hydrocarbon and terpene resin compositions or the ASTM D5296-05 method for determining the molecular weight averages and molecular weight distribution of polystyrene compositions may be used. These methods use Gel Permeation Chromatography (GPC), also known as size-exclusion chromatography. In particular, the weight percentage values of each of the components of the oligoterpene composition may be determined based on the area of the peaks obtained in a Gel Permeation chromatogram of the oligoterpene composition.

The oligoterpene composition as described herein may be obtained, in whole or in part, from a monoterpene containing two isoprene moieties. Oligoterpenes may be obtained, for instance, by polymerization of one or more monoterpenes by methods known to the skilled person, e.g. by treating the monoterpene with a Lewis acid catalyst such as aluminum chloride (AlCl₃) and boron trifluoride (BF₃).

Said monoterpene may generally be an unsubstituted unsaturated terpene C10 hydrocarbon. Examples of unsubstituted monoterpenes include, for example, α-pinene, β-pinene, δ-2-carene, δ-3-carene, dipentene, limonene, myrcene, β-phellandrene, α-terpinene, γ-terpinene and terpinolene. Such terpenes are commercially available and are generally directly obtained or derived from tree extract, particularly from coniferous trees. Dipentene and δ-2-carene are generally obtained by isomerization of α-pinene and δ-3-carene respectively. Myrcene is generally derived from β-pinene by pyrolysis.

In one embodiment the oligoterpene composition as described herein is obtained from α-pinene, β-pinene, δ-3-carene and limonene or combinations thereof and in particular from α-pinene. α-Pinene advantageously is more generally available than other monoterpenes and has a higher reactivity for polymerization.

Accordingly, an oligoterpene composition as described herein may comprise an oligoterpene comprising at least one unit with the following structure:

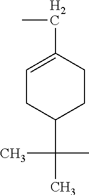

which results from using α-pinene for the preparation of the oligoterpene. It is understood that the oligoterpene composition may also comprise α-pinene, e.g. residual α-pinene present in the polymerization product.

Generally, the polymerization product may comprise a combination of oligoterpenes. An oligoterpene polymerization product rich in one oligoterpene or comprising a specific combination of oligoterpenes may be obtained by adjusting the polymerization conditions and/or by fractionating, selecting and combining appropriate oligoterpene polymerization products. Thus, the different oligoterpenes in the oligoterpene composition may be obtained separately or together as a mixture.

The oligoterpene polymerization product is generally used as the oligoterpene composition as described herein and generally consists of a mixture of different oligoterpenes.

Generally, asphalt mixtures as described herein may comprise from 0.01 to 20 wt. % of the oligoterpene composition, in particular from 0.01 to 15 wt. %, and more in particular from 0.01 to 10 wt. The % by weight is based on the total weight of the asphalt mixture. In different embodiments, the asphalt mixture may comprise from 0.025 to 2 wt. % of the oligoterpene composition, in particular from 0.05 to 1 wt. %, more in particular from 0.1 to 0.75 wt. %, even more in particular from 0.15 to 0.5 wt. %.

In several embodiments asphalt mixtures as described herein comprise reclaimed asphalt. For instance asphalt mixtures as described herein may comprise at least 15 wt. % of reclaimed asphalt, the % by weight is based upon the total weight of the asphalt mixture. In different embodiments, the asphalt mixture may comprise at least 25 wt. % of reclaimed asphalt based on the total weight of the asphalt mixture, at least 50 wt. %, at least 75 wt. %, at least 85 wt. %, or at least 90 wt. %.

In a particular embodiment the asphalt mixture may consist of a mixture of 0.01 to 15 wt. % of the oligoterpene composition and of 85 to 99.99 wt. % of reclaimed asphalt, based on the total weight of the asphalt mixture.

Optionally, in addition to the oligoterpene composition and reclaimed asphalt, asphalt mixtures as described herein may comprise at least one of a bituminous binder and an aggregate, which may be added to total 100% of the weight of the asphalt mixture. Accordingly, the asphalt mixture may generally comprise less than about 85 wt. % (e.g. 84.99 wt. %) of at least one of a bituminous binder and an aggregate. As more reclaimed asphalt is used in an asphalt mixture, of course, less additional bitumen and/or aggregate is used. However, other components, such as the supplementary components described above for the bituminous binder, may be present in the asphalt mixture instead of or in addition to the bituminous binder and/or aggregate.

In one embodiment the asphalt mixture may comprise, besides the oligoterpene composition and the reclaimed asphalt, additional bituminous binder. The additional bituminous binder may preferably be virgin bitumen, in particular polymer modified bitumen. In a particular embodiment the asphalt mixture may further comprise aggregate.

In another embodiment the asphalt mixture may comprise, besides the oligoterpene composition and the reclaimed asphalt, at least one supplementary component selected from an elastomer, plastomer, a non-bituminous binder, an adhesion promoter, a softening agent and an additional rejuvenating agent other than oligoterpene. In a particular embodiment the asphalt mixture may further comprise aggregate.

In yet another embodiment the asphalt mixture may comprise, besides the oligoterpene composition and the reclaimed asphalt, virgin asphalt (i.e. virgin bitumen and, optionally, virgin aggregate), and optionally a supplementary component as defined above.

Alternatively an asphalt mixture as described herein may comprise the oligoterpene composition and virgin asphalt. For instance the asphalt mixture may consist of oligoterpene composition and virgin asphalt or may optionally further comprise supplementary components as defined above. For instance, in one embodiment the asphalt mixture may consist of a mixture of 0.01 to 15 wt. % of the oligoterpene composition and of 85 to 99.99 wt. % of virgin asphalt, based on the total weight of the asphalt mixture. In several particular embodiments, virgin asphalt may comprise polymer modified bitumen. The amount of the oligoterpene composition in the asphalt mixture as described herein may be adjusted relative to the total amount of bituminous binder present in the asphalt mixture (including bituminous binder of reclaimed asphalt origin and virgin binder). The amount of oligoterpene may be, for instance, from 0.1 to 20 wt. % of the total amount of bituminous binder, in particular from 1 to 10 wt. %, more in particular from 2.5 to 7.5 wt. %. The % by weight is based on the amount of bituminous binder. Higher or lower amounts of oligoterpene relative to the amount of bituminous binder may also be used. Generally, relative amounts lower than 0.1 wt. % may still provide a rejuvenating effect, even if to a lesser extent. On the other hand, the use of relative amounts higher than 20 wt. % does not negatively affect the performance of the final asphalt mixture, even if the use of such higher amounts may not significantly increase rejuvenation.

The amount of bituminous binder present in an asphalt composition (e.g. reclaimed asphalt and/or virgin asphalt) is generally known, e.g. from the supplier, but may also be determined by methods known to the skilled person. For instance, a known amount of asphalt may be treated with a suitable solvent, e.g. dichloromethane, and the weight amount of bituminous binder in the extracted fraction may be measured, thereby determining the content of bituminous binder in the asphalt. Typically, the amount of bituminous binder in an asphalt that also comprises aggregate may range from 1 to 10 wt. % based on the total weight of the asphalt, in particular from 2.5 to 8.5 wt. % and more particular from 4 to 7.5 wt. %.

An aspect of this invention relates to a method for preparing an asphalt mixture comprising reclaimed asphalt and/or virgin asphalt. The method comprises mixing an oligoterpene composition with reclaimed asphalt and/or virgin asphalt. In one embodiment the method may comprise mixing an oligoterpene composition with reclaimed asphalt and/or virgin asphalt, with at least one of a bituminous binder and an aggregate. The different components may be mixed in any order, or may be mixed together as pre-mixes, e.g. by making a pre-mix of two or more components and then mixing the pre-mix with other components or with other pre-mixes.

It is noted that the oligoterpenes of the oligoterpene composition may be added separately or together as a pre-mix at any stage of the mixing method. However, since the preparation of oligoterpenes may generally provide an oligoterpene composition comprising a mixture of oligoterpenes, the oligoterpenes are generally added as a pre-mix.

In one embodiment, the asphalt mixture is prepared by mixing the oligoterpene composition with the reclaimed asphalt and/or virgin asphalt, to provide an oligoterpene-asphalt mixture. Optionally, an oligoterpene-asphalt mixture comprising reclaimed asphalt may be subsequently mixed with at least one of a bituminous binder and an aggregate. Additionally or alternatively, the oligoterpene-asphalt mixture (comprising reclaimed asphalt and/or virgin asphalt) may be subsequently mixed with at least one supplementary component selected from the supplementary components described above for the bituminous binder.

The oligoterpene composition, aggregate and/or any supplementary components may be added to the reclaimed asphalt and/or virgin asphalt separately from bitumen to form an asphalt mixture. Alternatively, the oligoterpene composition, aggregate and/or any supplementary components may be added to the reclaimed asphalt and/or virgin asphalt as a pre-mix with bitumen. As described above for the bituminous binder, the supplementary components include components that are commonly used and/or suitable for use in asphalt such as elastomers, plastomers, and non-bituminous binders. Other supplementary components may include, for instance, adhesion promoters, softening agents, additional rejuvenating agents (other than those of the invention), and other additives that are suitable for asphalt applications and generally known in the paving industry. Any supplementary components of the bituminous binder may be added to the asphalt mixture at any stage of the method.

In a particular embodiment, the method as described herein may comprise the steps of first making a bituminous binder-oligoterpene blend, by mixing the oligoterpene composition with the bituminous binder, and then mixing the blend with the reclaimed asphalt, and, optionally, with at least one of additional bituminous binder, aggregate, a supplementary component as discussed above such as elastomers, plastomers, and non-bituminous binders. Other supplementary components may include, for instance, adhesion promoters, softening agents, additional rejuvenating agents (other than those of the invention), and other additives that are suitable for asphalt applications and generally known in the paving industry.

In several embodiments the asphalt mixture is prepared by mixing the oligoterpene composition with virgin asphalt. The virgin asphalt may be mixed as such with the oligoterpene composition, or the different components of the virgin asphalt (virgin bitumen and virgin aggregate) may be mixed separately. For instance, bituminous binder comprising virgin bitumen may be mixed with the oligoterpene composition to form a premix, and subsequently be mixed with virgin aggregate and, optionally, at least one of additional bituminous binder, additional aggregate, a supplementary component as discussed above such as elastomers, plastomers, and non-bituminous binders. Other supplementary components may include, for instance, adhesion promoters, softening agents, additional rejuvenating agents (other than those of the invention), and other additives that are suitable for asphalt applications and generally known in the paving industry.

If the bituminous binder in addition to bitumen comprises supplementary components as described above, then the oligoterpene composition, the bitumen and any supplementary components may be mixed in the following manner:
some or all of the supplementary components may be already present together with bitumen in the bituminous binder prior to mixing with the oligoterpene composition;
some or all of the supplementary components may be mixed with the bituminous binder together with the oligoterpene composition, and/or
some or all of the supplementary components may be added separately from the bituminous binder-oligoterpene blend in a later stage of the process.

A blend of bituminous binder and oligoterpene composition may be provided by mixing the oligoterpene composition and the bituminous binder at the asphalt-producing site, in what is known as a terminal blending process.

Alternatively, the oligoterpene composition and the bituminous binder may be mixed at a refinery plant, i.e. where bitumen is produced. When mixed at the refinery, a blend is obtained that may then brought to the asphalt-producing site for mixing with the remaining components, e.g., the reclaimed asphalt, the aggregate and/or supplementary components.

A useful bituminous binder-oligoterpene blend as described above comprises from 50 to 99.5 wt. % of bituminous binder and from 0.5 to 50 wt. % of the oligoterpene composition, based on the total weight of the bituminous binder-oligoterpene blend. For example, a bituminous binder-oligoterpene blend may comprise from 2 to 45 wt. % of the oligoterpene composition, from 5 to 20 wt. %, or from 7 to 17 wt. %.

A bituminous binder-oligoterpene blend as described herein is very suitable for direct use in the preparation of asphalt mixtures comprising reclaimed asphalt and/or virgin asphalt, as it already has the rejuvenating agent incorporated therein. Having the rejuvenating agent premixed with the bituminous binder allows more controlled dosing of the oligoterpene composition, compared to adding oligoterpene directly to reclaimed asphalt and/or virgin asphalt. In addition, using a bituminous binder-oligoterpene blend facilitates mixing of the oligoterpene with the asphalt and improves the distribution of oligoterpene in the final asphalt mixture.

Mixing of the different components to provide the asphalt mixture as described herein may be performed by using standard means and methods known to the skilled person, e.g. by using suitable blending and/or mixing apparatuses and processes. In particular, hot asphalt mixing, warm mixing and half-warm mixing and cold asphalt mixing processes may be used.

In one embodiment hot asphalt mixing processes are useful. In this embodiment, the different components may be heated prior to and/or during mixing. Suitable temperatures are generally from 100 to 300° C. The bituminous binder-oligoterpene blend, or each of the oligoterpene composition and bituminous binder separately, are generally heated to a temperature from 100 to 200° C. in particular from 160 to 180° C. prior to mixing with the other components. The aggregate may also be heated prior to mixing, generally to a temperature from 200 to 300° C., in particular to from 220 to 250° C. The reclaimed asphalt is generally heated during mixing, e.g. by heat transfer from the other heated components. When heated prior to mixing the reclaimed asphalt may be heated to at most 150° C., in particular to at most 130° C.

The relative amounts of the oligoterpene composition, reclaimed asphalt and/or virgin asphalt and any additional components as described above for the asphalt mixture, are used in the methods for preparing asphalt mixtures as described herein.

Another aspect of the invention relates to a method for rejuvenating reclaimed asphalt or treating virgin asphalt, comprising the step of mixing an oligoterpene composition with reclaimed asphalt and/or virgin asphalt. In particular the method may comprise mixing an oligoterpene composition with reclaimed asphalt and/or virgin asphalt to provide a modified asphalt comprising the oligoterpene composition. In particular the amount of the oligoterpene composition in the modified asphalt may be as described above for the asphalt mixtures of the invention. In addition to mixing an oligoterpene composition to reclaimed asphalt, the method for rejuvenating reclaimed asphalt pavement may further comprise mixing a bituminous binder to reclaimed asphalt. In particular, the oligoterpene composition may be provided pre-blended with a bituminous binder and then mixed with reclaimed asphalt. A bituminous binder-oligoterpene blend as described above may be used.

The methods described herein result in a rejuvenating effect on reclaimed asphalt and may improve the ageing properties of virgin asphalt. Further, virgin asphalt treated by a method as described herein, may be used together with reclaimed asphalt to impart rejuvenating properties to the reclaimed asphalt.

The asphalt mixtures and methods as described herein may be suitably used for forming a pavement using standard pavement-laying processes known to the skilled person. Other applications wherein asphalt is usually used may also be suitable, such as roofing applications.

The instant invention is further illustrated with the following examples without being limited thereto or thereby.

### EXAMPLES

### Preparation of Oligoterpene A

In a 1 L four necked reaction flask, equipped with thermometer, overhead stirrer, nitrogen purge, addition line and a sampling port a slurry of 7.0 g of aluminum chloride (with a purity higher than 98.5% from Acros, Belgium) and 160 g of xylene (with a purity higher than 98% from VWR, The Netherlands) are charged under nitrogen atmosphere. The reactor is heated to a temperature from 45 to 47° C. When this temperature is reached, α-pinene (with purity higher than 94% from Arizona Chemical, Finland) is added at a rate of 2-3.5 grams per minute, to a total of 200 g of α-pinene. After all α-pinene is added the reactor is left at 45-47° C. for 60 minutes. After this time the aluminum chloride is neutralized with 100 g of water. The neutralization is carried out by stirring continuously at 75-80° C. for 15 minutes. Thereafter the stirrer is switched off and the mixture is left to stand for 30 minutes to allow the separation of the organic phase and the aqueous phase. The aqueous phase is then decanted and the organic phase is washed with water. The organic phase is then heated to 120° C. and the evaporated residual water and xylene are condensed and collected. When no more vapor is visibly condensing, the reactor is heated to 180° C. and any volatile material is collected. When no vapor was visibly condensing, the reactor is then heated to 240° C. and a nitrogen sparge was started to strip-off further volatiles until a viscosity specification from 4000 to 4500 mPa·s at 50° C. is reached. The residue obtained is the oligoterpene composition referred to as oligoterpene A.

The viscosity of the product is measured according to the ASTM D2196 method which uses Brookfield equipment and provides a rotational viscosity measurement.

The composition of oligoterpene A was determined by GPC according to the ASTM D5296-05 method for determining molecular weight averages and molecular weight distribution of polystyrene by high performance size-exclusion chromatography. 30 μL of a sample of the polymerization product (about 50 mg) dissolved in 2000 μL of THF (99+% from Aldrich, Belgium) was injected to a HPCL machine (HPLC system equipped with a Waters 515 HPLC pump; Waters 717 plus Autosampler; Waters 2414 Refractive Index Detector and Waters Column Heater Module) fitted with a two mixed E columns (from Polymer laboratories): one 50 Angstrom column and a 3 micron guard column. Each sample was run with an isocratic THF solvent system over 35 minutes.

In order to establish the correlation between the retention time and the Mw, a calibration was performed using a commercially available polystyrene standard with molecular weights from 580 g-mol-l to 380000 g-mol-l (PS 2 EasiCal from Polymer Laboratories, USA)

The measured Mw of each of the components of the oligoterpene A was obtained based on their retention time and by using the polystyrene calibration as reference values.

The measured Mw of the monoterpene α-pinene (with a theoretical Mw of 136) was determined under the same conditions and was found to be of 116. This measurement was used to correlate the measured Mw values (based on the polystyrene calibration) with the theoretical Mw, for each of the components identified in the GPC chromatogram of the oligoterpene A composition. The results are given in Table 1.

TABLE 1

| | | |
|---|---|---|
| | | Type of Oligoterpene |
| Peak Area | Measured MW values | (theoretical MW values) |

α-Pinene

| | | |
|---|---|---|
| 100% | 116 | Monoterpene (136) |

Oligoterpene A

| | | |
|---|---|---|
| 38.0% | 208 | Diterpene (272) |
| 22.5% | 334 | Triterpene (408) |
| 16.2% | 467 | Tetraterpene (544) |
| 6.7% | 593 | Pentaterpene (680) |
| 14.7% | 689 | Hexaterpene (816) |

### Preparation of Test Samples

Samples of bituminous binder were obtained from several suppliers. Non-modified bitumen was obtained from Q8, The Netherlands. Polymer modified bitumen was obtained from Shell, The Netherlands. Aged bitumen was obtained according to ASTM D6521 using the pressure aging vessel, whereby a PEN 35/50 graded bitumen was aged using a temperature of 100° C. for 40 hours.

The samples for dosing the additives were prepared by heating the bituminous binders to 135° C. for 90-120 minutes to obtain a homogenous bitumen sample. From the heated container a predetermined weight was added into a 50 ml beaker. Additives were dosed at a dosage level of 5 wt. % to the bituminous binders. The samples were stirred and placed back into the oven for 10 minutes. After 10 minutes samples were taken out of the oven and stirred again. The samples are ready to be used for further evaluation.

TABLE 2

| Sample | Virgin | Aged | |
|---|---|---|---|
| (additive) | bitumen | bitumen | Additive |
| Comp. Ex. 1 (virgin, no additive)*** | 100 g | | |
| Comp. Ex. 2 (virgin, no additive)** | 100 g | | |
| Comp. Ex. 3 (aged, no additive)* | | 100 g | |
| Comp. Ex. 4 (mix, no additive) | 30 g | 70 g | |
| Comp Ex. 5 (flux oil) | 26.5 g | 70 g | 3.5 g |
| Ex. 1 (oligoterpene A) | 26.5 g | 70 g | 3.5 g |
| Ex. 2 (oligoterpene B) | 26.5 g | 70 g | 3.5 g |
| Comp Ex.6 (flux oil)* | | 95 | 5 |
| Ex. 3 (oligoterpene A)* | | 95 | 5 |
| Ex. 4 (oligoterpene B)* | | 95 | 5 |
| Comp Ex 7 (flux oil)** | 95 | | 5 |
| Ex. 5 (oligoterpene A)** | 95 g* | | 5 g |
| Ex. 6 (oligoterpene B)** | 95 g* | | 5 g |
| Comp Ex 8*** | 95 | | 5 |
| Ex. 7 (oligoterpene A)*** | 95 g | | 5 g |
| Ex. 8 (oligoterpene B)*** | 95 g | | 5 g |

*Laboratory aged binder with PAV for 40 hours at 90° C.
**polymer modified bitumen Styrelf ex-Shell
***PEN 35/50 ex-Q8 petroleum

### Measurements and Results

A sample of each bitumen composition was taken for measuring the Ring & Ball softening point, the glass transition temperature and the rheological profile (Tables 2, 3 and 4).

The Ring & Ball softening point was measured in water according to the Ring and Ball method ASTM E28-99. A sample of the bitumen compositions prepared above was poured into a metal ring, when still warm and subsequently cooled. The ring was cleaned in such a way that the material fitted the ring, a steel ball was placed resting on top of the material. The ring and ball were lowered into a beaker containing water, and the water was heated at 5° C. per minute while being stirred. When the ball dropped completely through the ring, the temperature of the water was recorded. The temperature value is reported in as the Ring & Ball softening point.

The Ring & Ball softening point of bitumen is an indicator of the stiffness of asphalt wherein the bitumen is used.

The glass transition temperature (Tg) was measured with a Methler DSC apparatus with the following parameters:
Gas: Nitrogen 65 ml/min
Cup: Standard Aluminum 40 μl cup with small hole on the lid
Temperature:
   From 25.0° C. to −60.0° C. at a rate of 10° C. per minute
   From −60.0° C. to 25.0° C. at a rate of 10° C. per minute

The glass transition temperature of bitumen is an indicator of the brittleness of asphalt wherein the bitumen is used.

More in depth analysis was made using a Dynamic Shear Rheometer (DSR). For this study the test used a 10 mm plate, with a 2.5 mm gap and was run at one frequency (10 rad/s) in a range of −30° C. to +100° C. These measurements are used to assess the performance of the bituminous binder at high, intermediate and low temperatures.

Viscoelastic behavior of the bitumen at temperatures below 15° C. is an indicator of the tendency to crack at low temperatures of asphalt wherein the bitumen is used. The viscoelastic behavior may be expressed in terms of the Storage Modulus and the Loss Modulus. The lower the Storage Modulus and the Loss Modulus the lower is the tendency to crack.

TABLE 3

| | Ring | | 1-Glass | 2-Glass |
|---|---|---|---|---|
| | and Ball | Pene- | transition | transition |
| Sample | Softening | tration | temperature | temperature |
| (additive) | point (° C.) | (dmm) | −Tg (° C.) | −Tg (° C. |
| Comp. Ex. 1 | 54.2 | 30 | −19.9 | 16.7 |
| (virgin, no additive)*** | | | | |
| Comp. Ex. 2 | 70.3 | 49 | −28.5 | 6.9 |
| (virgin, no additive)** | | | | |
| Comp. Ex. 3 | 66.8 | 13 | −22.4 | 14.7 |
| (aged no additive)* | | | | |
| Comp. Ex. 4 | 61.3 | 20 | −19.5 | 17.7 |
| (mix, no additive) | | | | |
| Comp Ex. 5 (flux oil) | 56.2 | 36 | −23.1 | 13.7 |
| Ex. 1 (oligoterpene A) | 57.7 | 30 | −20.8 | 15.5 |
| Ex. 2 (oligoterpene B) | 60.9 | 18 | −18.1 | 19.0 |
| Comp Ex. 6 (flux oil)* | 62.0 | 21 | −17.5 | 20.7 |
| Ex. 3 (oligoterpene A)* | 62.9 | 18 | −20.3 | 15.9 |
| Ex. 4 (oligoterpene B)* | 67.6 | 12 | −20.4 | 14.9 |
| Comp. Ex. 7 (flux oil)** | 69.3 | 64 | −29.0 | 6.3 |
| Ex. 5 (oligoterpene A)** | 69.0 | 59 | −27.2 | 8.1 |
| Ex. 6 (oligoterpene B)** | 70.6 | 41 | −26.2 | 12.2 |
| Comp. Ex. 8(flux oil))*** | 43.5 | 93 | −22.9 | 12.0 |
| Ex. 7 (oligoterpene A)*** | 54.9 | 26 | −21.1 | 14.9 |
| Ex. 8 (oligoterpene B)*** | 51 | 46 | −18.4 | 19.3 |

*Laboratory aged binder with PAV for 40 hours at 90° C.;
**polymer modified bitumen Styrelf ex-Shell;
***PEN 35/50 ex-Q8 petroleum

TABLE 4

| | Temperature [° C.] | | | | | | | | | |
|---|---|---|---|---|---|---|---|---|---|---|
| | −20 | −15 | −10 | −5 | 0 | 5 | 10 | 15 | 20 | 25 |
| Sample (additive) | Storage Modulus [MPa] | | | | | | | | | |
| Comp. Ex. 1 (virgin, no additive)*** | 593 | 488 | 316 | 218 | 141 | 84.8 | 35.8 | 12.5 | 5.4 | 2.1 |
| Comp. Ex. 2 (virgin, no additive)** | 380 | 241 | 171 | 93.4 | 57.6 | 24.3 | 12.1 | 5.7 | 1.7 | 0.7 |
| Comp. Ex. 3 (aged no additive)* | | 499 | 400 | 306 | 191 | 108 | 69.5 | 41.6 | 16.5 | 8 |
| Comp. Ex. 4 (mix, no additive) | | 483 | 339 | 208 | 145 | 95.8 | 44.9 | 24.1 | 11.8 | 3.55 |
| Comp Ex. 5 (flux oil) | 565 | 399 | 296 | 174 | 115 | 71.5 | 30.4 | 10.1 | 4.4 | 1.9 |
| Ex.1 (oligoterpene A) | 606 | 428 | 272 | 190 | 127 | 63 | 35.8 | 12.9 | 6 | 2.6 |
| Ex. 2 (oligoterpene B) | | 433 | 345 | 211 | 143 | 92.7 | 44.3 | 24.7 | 12.6 | 3.8 |
| Comp Ex.6 (flux oil)* | | | 338 | 207 | 137 | 89.4 | 44.9 | 27 | 10.1 | 4.6 |
| Ex.3 (oligoterpene A)* | | | 327 | 243 | 135 | 86.4 | 41.1 | 23.3 | 12.3 | 4 |
| Comp. Ex. 7 (flux oil)** | 326 | 200 | 139 | 71.6 | 43.6 | 17.3 | 8.2 | 3.6 | 0.9 | 0.4 |
| Ex. 5 (oligoterpene A)* * | 320 | 197 | 132 | 85.3 | 39.3 | 21.4 | 7 | 3 | 1.2 | 0.3 |
| Ex. 6 (oligoterpene B)** | 426 | 317 | 205 | 137 | 85.6 | 41 | 14.8 | 6.4 | 2.5 | 0.7 |
| Comp. Ex. 8(flux oil))*** | 314 | 253 | 190 | 112 | 74.5 | 36 | 18.9 | 5.9 | 2.5 | 0.5 |
| Ex. 7 (oligoterpene A)*** | 532 | 425 | 262 | 171 | 103 | 43.3 | 22.5 | 7 | 2.9 | 0.6 |
| Ex. 8 (oligoterpene B)*** | 672 | 574 | 406 | 291 | 193 | 90.8 | 50.9 | 18.3 | 8.2 | 2 |
| Sample (additive) | Loss Modulus [MPa] | | | | | | | | | |
| Comp. Ex. 1 (virgin, no additive)*** | 81.6 | 90.1 | 92.9 | 83.3 | 68.3 | 51.5 | 29.7 | 14.3 | 7.8 | 3.9 |
| Comp. Ex. 2 (virgin, no additive)** | 86.1 | 77.3 | 67.3 | 47.6 | 34.8 | 18.8 | 11.2 | 6.2 | 2.4 | 1.2 |
| Comp. Ex. 3 (aged no additive)* | | | 87 | 81.6 | 69.2 | 51 | 39 | 27.7 | 14.4 | 8.4 |
| Comp. Ex. 4 (mix, no additive) | | 89.5 | 88.1 | 75.7 | 63.1 | 49 | 30.5 | 19.7 | 11.7 | 4.7 |
| Comp Ex. 5 (flux oil) | 80 | 92.1 | 88.7 | 72.5 | 58.4 | 43.7 | 24.6 | 11 | 5.9 | 3 |
| Ex.1 (oligoterpene A) | 84.1 | 97.4 | 89.3 | 76.2 | 62.1 | 40.2 | 27.4 | 13 | 7.3 | 3.8 |
| Ex. 2 (oligoterpene B) | | 77.2 | 79.7 | 72.1 | 61.1 | 48.6 | 30.6 | 20.6 | 12.7 | 5.3 |
| Comp Ex.6 (flux oil)* | | | 88.4 | 75 | 60.8 | 47.2 | 30.1 | 21.2 | 10.3 | 5.7 |
| Ex.3 (oligoterpene A)* | | | 88.4 | 80.3 | 60.1 | 46.3 | 28.3 | 18.9 | 11.9 | 5.2 |
| Ex. 4 (oligoterpene B)* | | | 80.2 | 78.7 | 68.1 | 56.4 | 43.8 | 26.8 | 18.1 | |
| Comp. Ex. 7 (flux oil) ** | 88 | 85.3 | 75 | 61.7 | 47 | 28.9 | 13.8 | 7.3 | 3.5 | 1.3 |
| Ex. 5 (oligoterpene A)* * | 81.8 | 71.3 | 58.7 | 45.3 | 26.8 | 17.2 | 7.4 | 3.8 | 1.9 | 0.6 |
| Ex. 6 (oligoterpene B)** | 88 | 85.3 | 75 | 61.7 | 47 | 28.9 | 13.8 | 7.3 | 3.5 | 1.3 |
| Comp. Ex. 8(flux oil))*** | 48.2 | 54.7 | 56.6 | 50.5 | 43.1 | 29 | 18.9 | 8.3 | 4.4 | 2.1 |
| Ex. 7 (oligoterpene A)*** | 74.3 | 87.9 | 86.1 | 74.3 | 58.1 | 34.3 | 22.1 | 9.6 | 4.9 | 1.6 |
| Ex. 8 (oligoterpene B)*** | 68.4 | 83.6 | 96.6 | 94 | 81.8 | 56.5 | 39.9 | 20.2 | 11.4 | 4 |

*Laboratory aged binder with PAV for 40 hours at 90° C.;
**polymer modified bitumen Styrelf ex-Shell;
***PEN 35/50 ex-Q8 petroleum

TABLE 5
Comparison in virgin PEN 35/50 PEN graded bitumen

| Sample | Ring & Ball | | Storage | Loss |
|---|---|---|---|---|
| (additive) | softening point | Tg | Modulus | Modulus |
| Comp Ex. 5 (flux oil) | + | + | + | + |
| Ex. 1 (oligoterpene A) | + | + | + | + |
| Ex. 2 (oligoterpene B) | − | − | − | − |

TABLE 6
Comparison in virgin polymer modified bitumen

| | | | |
|---|---|---|---|
| Sample | Ring & Ball | Storage | Loss |

| | | | | |
|---|---|---|---|---|
| (additive) | softening point | Tg | Modulus | Modulus |

| | | | | |
|---|---|---|---|---|
| Comp Ex. 5 (flux oil) | − | + | + | + |
| Ex. 1 (oligoterpene A) | − | + | + | + |
| Ex. 2 (oligoterpene B) | − | + | − | − |

TABLE 7
Comparison in laboratory aged bitumen

| Sample | Ring & Ball | | Storage | Loss |
|---|---|---|---|---|
| (additive) | softening point | Tg | Modulus | Modulus |
| Comp Ex. 5 (flux oil) | + | + | + | + |
| Ex. 1 (oligoterpene A) | + | + | + | + |
| Ex. 2 (oligoterpene B) | − | − | − | − |

TABLE 8
Comparison in a mix of 70% aged and 30% virgin bitumen

| Sample | Ring & Ball | | Storage | Loss |
|---|---|---|---|---|
| (additive) | softening point | Tg | Modulus | Modulus |
| Comp Ex. 5 (flux oil) | + | + | + | + |
| Ex. 1 (oligoterpene A) | + | + | + | + |
| Ex. 2 (oligoterpene B) | − | − | − | − |

Tables 5-8 present an overview of the performance of each of the additives used with respect to virgin bitumen (Comp. Ex. 4), i.e. the sample with the target performance. A negative sign (−) indicates no improvement or no significant improvement with respect to comparative example 4 and a positive sign (+) indicates an improvement. The higher the number of positive signs the higher the improvement.

As it can be seen from the results presented in Tables 2, 3, 4 and 5, oligoterpenes act as modifiers for bituminous products altering at least some of the properties. In particular, oligoterpene A (Ex.1) improves the softening point and the glass transition temperature of bitumen mixtures. It improves the low temperature properties of each bituminious product used in the examples. Oligoterpene A also provides an improvement on the storage modulus at temperatures from 0 to 25° C. and on the loss modulus at temperatures from 15 to 25° C. (see tables 2 and 4).

1. An asphalt mixture comprising an oligoterpene composition and reclaimed asphalt and/or virgin asphalt comprising bituminous binder, wherein the oligoterpene composition comprises at least one oligoterpene with at least two isoprene moieties selected from a diterpene, a triterpene, a tetraterpene, a pentaterpene and a hexaterpene.

2. The asphalt mixture of claim 1 comprising reclaimed asphalt and, optionally, further comprising at least one of additional bituminous binder and an aggregate.

3. The asphalt mixture of claim 1 comprising virgin asphalt, wherein the virgin asphalt optionally comprises polymer modified bitumen.

4. The asphalt mixture of claim 1 further comprising at least one supplementary component selected from an elastomer, plastomer, a non-bituminous binder, an adhesion promoter, a softening agent and a rejuvenating agent other than an oligoterpene.

5. The asphalt mixture of claim 1 wherein the oligoterpene composition comprises a mixture of a diterpene, a triterpene, a tetraterpene, a pentaterpene and a hexaterpene.

6. The asphalt mixture of claim 1 wherein the asphalt mixture comprises 0.01-20 wt. % of the oligoterpene, wherein the % by weight is based on the total weight of the asphalt mixture.

7. The asphalt mixture of claim 1 wherein the asphalt mixture comprises at least 15 wt. % of the reclaimed asphalt, wherein the % by weight is based on the total weight of the asphalt mixture.

8. The asphalt mixture of claim 1 wherein the oligoterpene composition comprises at most 0.5 wt. % of monoterpene, wherein the % by weight is based on the total weight of the oligoterpene composition.

9. The asphalt mixture of claim 8 wherein the oligoterpene composition is free from monoterpene.

10. The asphalt mixture of claim 1 wherein the oligoterpene composition comprises an oligoterpene with at least one unit of the structure

11. A method of preparing the asphalt mixture of claim 1 comprising mixing an oligoterpene composition with reclaimed asphalt and/or virgin asphalt, wherein the oligoterpene composition comprises at least one oligoterpene with at least two isoprene moieties selected from a diterpene, a triterpene, a tetraterpene, a pentaterpene and a hexaterpene.

12. The method according to claim 11 comprising
a) first mixing a bituminous binder with the oligoterpene composition to provide a bituminous binder-oligoterpene blend, and then
b) mixing the blend with the reclaimed asphalt and, optionally, with at least one of additional bituminous binder, aggregate, an elastomer, a plastomer, a non-bituminous binder, an adhesion promoter, a softening agent and an additional rejuvenating agent other than an oligoterpene, to form an asphalt mixture comprising reclaimed asphalt.

13. The method according to claim 11 comprising
a) first mixing a bituminous binder comprising virgin bitumen with the oligoterpene composition to provide a bituminous binder-oligoterpene blend; and then
b) mixing the blend with virgin aggregate, and, optionally, with at least one of additional bituminous binder, additional aggregate, an elastomer, a plastomer, a non-bituminous binder, an adhesion promoter, a softening agent and an additional rejuvenating agent other than an oligoterpene, to form an asphalt mixture comprising virgin asphalt.

14. A blend of bituminous binder and an oligoterpene composition comprising 0.5-50 wt. % of the oligoterpene composition wherein the oligoterpene composition comprises at least one oligoterpene with at least two isoprene moieties selected from a diterpene, a triterpene, a tetraterpene, a pentaterpene and a hexaterpene and wherein the % by weight is based on the total weight of the blend.

15. A method for rejuvenating reclaimed asphalt or treating virgin asphalt, comprising mixing an oligoterpene composition with reclaimed asphalt and/or virgin asphalt to obtain a modified asphalt, wherein the oligoterpene composition comprises at least one oligoterpene with at least two isoprene moieties selected from a diterpene, a triterpene, a tetraterpene, a pentaterpene and a hexaterpene.
